(19) United States
(12) Patent Application Publication
(10) Pub. No.: US 2018/0046917 A1
(43) Pub. Date: Feb. 15, 2018

(54) IDENTIFICATION OF PROCESS ANOMALIES IN A TECHNICAL FACILITY

(71) Applicants: Thomas Bierweiler, Karlsruhe (DE); Henning Lenz, Karlsruhe (DE)

(72) Inventors: Thomas Bierweiler, Karlsruhe (DE); Henning Lenz, Karlsruhe (DE)

(21) Appl. No.: 15/674,331

(22) Filed: Aug. 10, 2017

(30) Foreign Application Priority Data
Aug. 11, 2016 (EP) 16183771.1

(51) Int. Cl. G06N 3/08

(52) U.S. Cl. CPC G06N 3/08

(57) ABSTRACT

Improved identification of a process anomaly in a technical facility includes training a self-organizing map using the historical process data as good states of the facility. The good states are used to determine a temporal sequence or a path of node hits and the tolerances of neuron hits. Threshold values are determined and stored for a Euclidean distance for the good states. The Euclidean distance of a current state vector to the neuron hit is checked as to whether the threshold value has been exceeded. The path determined is used to determine the neuron to be hit as long as the threshold value was not already exceeded in the check on the relevant neuron. A symptom vector from the current state vector and either the neuron hit or the neuron that is to be hit is determined.

This application claims the benefit of EP 16183771.1, filed on Aug. 11, 2016, which is hereby incorporated by reference in its entirety.

### BACKGROUND

The present embodiments relate to identification of process anomalies in a technical facility.

In production-technology and process-engineering facilities, analog and digital signals are generated, evaluated, and archived. Various methods, such as neuronal networks, support vector machines (SVM), or self-organizing maps (SOM) are known for the evaluation of historical data.

Self-organizing maps are very suitable for classifying conditions in historical data. At runtime, it is possible for deviations, or anomalies, from the normal process state to be identified. Depending on the database, faulty states may be classified. If known ‘good states’ are present in a facility, these may be used to teach self-organizing maps. Thus, self-organizing maps may be used to identify deviations during an ongoing operation. The use of SOMs to monitor facilities is, for example, described in EP2472440B1.

Following the identification of a deviation, for root cause analysis, it is useful to determine deviations of individual measuring points from good states and to build a symptom vector therefrom. The symptom vector may then be used as the basis for root cause analysis. One possible method for determining the cause from a symptom vector is, for example, described in EP2587329B1.

The use of these known methods or systems has two main drawbacks. To avoid critical system states, it is important for deviations from normal process behavior to be identified at an early stage. The self-organizing maps form different system states in corresponding nodes (e.g., in the case of dynamic processes). Therefore, it is possible for situations to occur in which states with deviations from their normal state are similar to other system states. These situations (e.g., as deviations) are then not identified by known methods or diagnostic systems or are only identified belatedly.

A reliable root cause analysis is not possible with known methods or systems since these are not always able to determine a symptom vector correctly in the event of an error. In addition, it is also not possible to identify deviations from the temporal behavior.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method for improved identification of process anomalies in a technical facility and a corresponding diagnostic system with which the above discussed drawbacks may be minimized are provided.

One or more of the present embodiments relate to a method and a diagnostic system for improved identification of a process anomaly in a technical facility with which initially a self-organizing map is trained using historical process data as good states of the facility. Good states are used to determine a temporal sequence or a path of node hits and tolerances for neuron hits. Threshold values for the Euclidean distance for the good states are determined and stored. The current process data in the facility is evaluated, with the threshold values, in the form of a state vector with the aid of the trained self-organizing map. The Euclidean distance of the current state vector to the neuron hit is checked as to whether the threshold value is exceeded. The determined path is used to determine a neuron that is to be hit as long as the threshold value was not already exceeded in the check with the neuron hit. A symptom vector from the current state vector and either the neuron hit or the neuron that is to be hit is determined. If, optionally together with the paths, the number of hits for a node is also stored, it is possible to determine temporal deviations from the good state.

The advantages include the early and reliable identification of deviations from the normal state and the correct determination of a symptom vector for better identification of the cause of the error.

### BRIEF DESCRIPTION OF THE DRAWINGS

FIG. 1 shows a self-organizing map to explain the method according to an embodiment; and

FIG. 2 shows a schematic depiction to explain the diagnostic system according to an embodiment.

### DETAILED DESCRIPTION

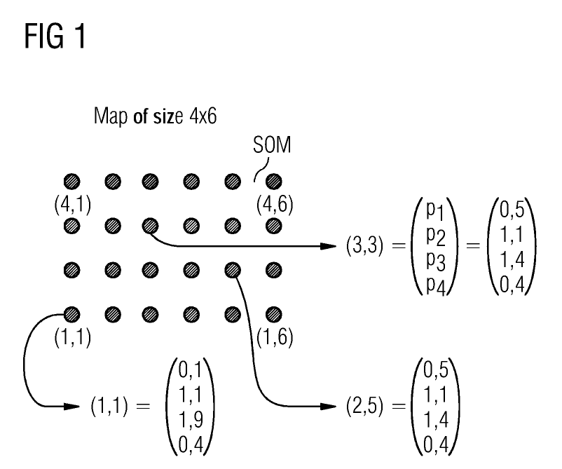

FIG. 1 shows, by way of example, a self-organizing map SOM with 4×6 nodes or neurons (1,1)-(4,6). Also shown by way of example are some state vectors in the map that are taught during a learning phase from historical input vectors for good states. The state vectors determined (shown in transposed form) are, for example, expressed as follows:

(1,1)=(0,1;1,1;1,9;0,4)^{T},

(2,5)=(0,5;1,1;1,9;0,4)^{T},

(3,3)=(0,5;1,1;1,4;0,4)^{T},

When teaching using historical data, the self-organizing map SOM is optimized such that all known process states (e.g., input vectors for good states) have the shortest possible Euclidean distance to the state vectors determined in the map.

In the learning phase, threshold values may be given for the Euclidean distances of the good states to the relevant neurons in the self-organizing map SOM.

Following optimization of the map SOM, threshold values for the individual nodal points may optionally be calculated automatically by re-evaluation of the good states.

In this way, optional application of a tolerance value to the threshold values produces a particularly stable and reliable depiction of the good state.

Runtime deviations are identified in that that the Euclidean distance between the current input vector and the state vector of the relevant node is greater than is normally the case. Herein, frequently, not only is the determined distance greater, but there may also, disadvantageously, be a change to the neuron hit or the relevant node in the map.

This is explained in more detail in the following using concrete examples based on the relationships shown in FIG. 1 (e.g., a taught map SOM with the size 4×6).

Here, let it be assumed that a current process vector PN in ongoing operation has, for example, the value

$${P}_{N} ( \begin{matrix}0.51 \\ 1.05 \\ 1.5 \\ 0.45\end{matrix} ) .$$

Let it be assumed that the node (3,3) is the node with the shortest Euclidean distance

$${Δ}_{N} = \vert {P}_{N} - ( 3 , 3 ) \vert = \vert ( \begin{matrix}0.01 \\ - 0.05 \\ - 0.1 \\ 0.05\end{matrix} ) \vert \approx 0.12 .$$

Taking into account a threshold value determined from the good states of, for example, 0.15, here, there is no deviation, and the symptom vector S_{N} is therefore obtained as

$${\vec{S}}_{N} = \vec{0} = ( \begin{matrix}0 \\ 0 \\ 0 \\ 0\end{matrix} ) .$$

Now, let it be assumed that there is a deviation. Instead of P_{N}, the process vector has, for example, the value

$${P}_{F 1} = ( \begin{matrix}0.49 \\ 1.15 \\ 1.85 \\ 0.35\end{matrix} ) .$$

The distance from node (3,3) for this case is then obtained as Δ_{F1;(3,3)}≈0.46. This would represent a deviation, and the deviation would be identified because the distance from node (3,3) lies above the relevant threshold value 0.15.

However, a further node taught in the map (2,5), which depicts the process values in another state, only has the distance Δ_{F1;(2,5)}≈0.09 to the above process vector P_{F1}. Therefore, the deviation is not identified due to the further node (2,5), and the system does not issue an alarm.

According to one or more of the present embodiments, this problem explained above using an example is resolved in that, as previously, in a first act, the map is taught from the good states. However, in a second additional act, the good states are used to determine and store the temporal sequence or reference paths of node hits. Herein, tolerances for neuron hits are also determined and stored and lead to reference path regions. In addition, as previously, threshold values for the Euclidean distance for the good states are determined and stored.

In the present case, the system would identify at runtime that it is necessary to determine the Euclidean distance to the correct node (3,3). This distance is obtained as Δ_{F1;(3,3)}≈0.46 and is significantly above the threshold value of 0.15; hence, the diagnostic system identifies a deviation.

To determine a correct symptom vector, a deviation is first identified and, second, the deviations from the process variables are determined based on the map node that would be hit in the good state of the facility.

Let it, for example, be assumed that a further process vector of a faulty state has the value

$${P}_{F 2} = ( \begin{matrix}0.15 \\ 1.15 \\ 1.85 \\ 0.35\end{matrix} ) .$$

The shortest Euclidean distance to the map is obtained from the node (1,1) as Δ_{F2;(1,1)}≈0.1. Therefore, a deviation is not identified; the symptom vector would be the zero vector \vec{0}.

Taking into account the path, the system according to one or more of the present embodiments now identifies that, as above, the node (3,3) should be hit. The Euclidean distance is then Δ_{F2;(3,3)}≈0.57 and, taking into account threshold values, the symptom vector is then obtained as

$${\vec{S}}_{F 2} = ( \begin{matrix}- 1 \\ 0 \\ 1 \\ 0\end{matrix} ) .$$

For example, the measuring point p1=−1 produces a measured value that is too low, the measuring point p3=1 gives a measured value that is too high, and the measuring points p2=0 or p4=0 do not flag any deviation.

This problem is resolved in that, during the teaching of the map, not only are the state vectors of the map nodes determined, the sequence of node hits, the paths, are also determined and stored.

This path tracing makes it possible, on the occurrence of deviations, to determine the node hit in the good state and then to use the node hit in the good state as the basis for the determination of a correct symptom vector that may be used for the accurate determination of the cause.

A further improvement to the diagnosis relates to the temporal duration of the states. As a rule, in digital systems, the scanning is performed in discrete time increments. If, together with the paths, the number of hits for a node are also stored, it is also possible to determine temporal deviations from the good state.

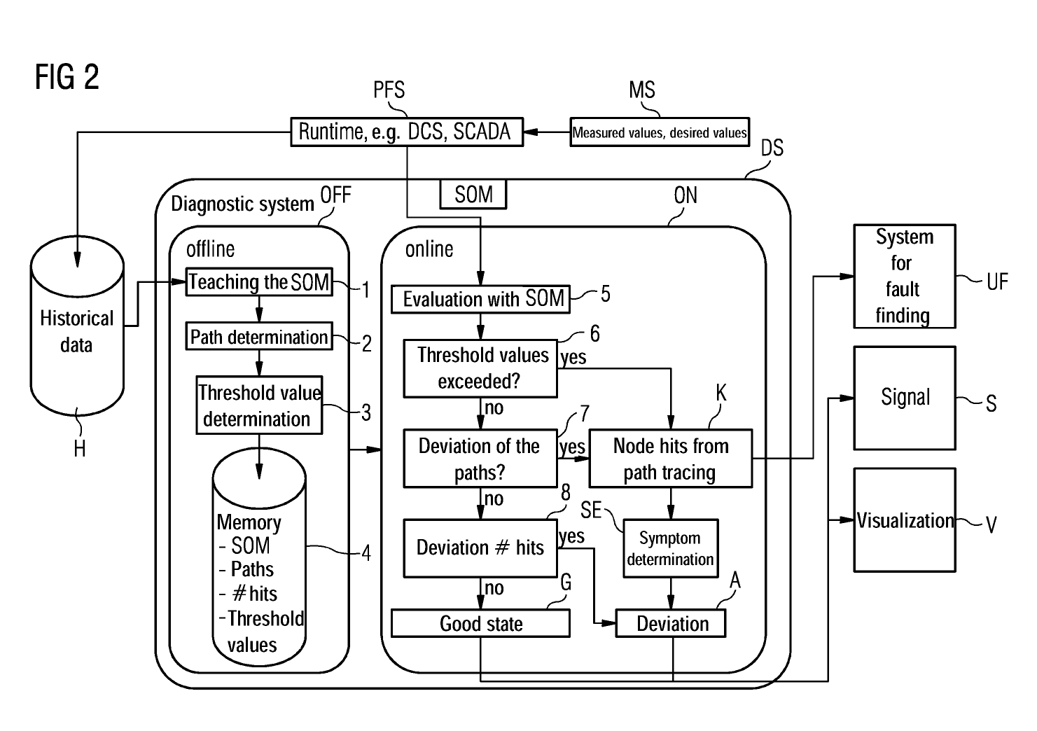

FIG. 2 is a schematic depiction to explain the diagnostic system DS according to one or more of the present embodiments with which a process control system PFS (e.g., DCS or SCADA) obtains measured values at runtime and specifies desired values. These measured and desired values MS are archived and form historical data H.

Offline OFF, initially, the self-organizing maps SOM are taught 1 with the aid of the historical data H and paths 2, threshold values 3, and optionally, the number of hits in the temporal sequence are determined and stored 4.

Online ON, then the current process values from the runtime of the process control system PFS are evaluated 5 by the self-organizing maps SOM. The data for the current process values are first checked as to whether threshold values are exceeded 6, and a node hit K (e.g., the neuron hit) is determined from path tracing, as long as the values are exceeded.

If the values are not exceeded, deviations of the current paths 7 are analyzed, and a node hit K is again determined from path tracing (e.g., the neuron that is to be hit) as long as there is a deviation.

From the node hit K from path tracing, a unit for symptom determination SE provides data (e.g., in the form of a symptom vector) for a system for root cause analysis UF, which is not the subject matter of the present embodiments and which enables more accurate error analysis. In addition, the symptom determination SE also provides a deviation A.

If no deviations of the paths 7 are identified, before the final identification of a good state, G, the number of temporally successive hits 8 may optionally be checked and the good state G or a deviation A, which is then used as an output signal S of the diagnostic system DS and/or sent for visualization V, may also be identified.

The determination and tracing of the paths or the sequence of node hits advantageously result in the early and reliable identification of deviations from the normal state, an additional possibility for identifying deviations in the temporal behavior, and a correct determination of a symptom vector based on the deviations of the individual process values from the good state; as an input variable of the system, this is used for the root cause analysis UF.

This enables anomalies in facilities to be identified early and reliably, and faulty states and unplanned shutdowns to be shortened or even avoided.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for improved identification of a process anomaly in a technical facility, the method comprising:
training a self-organizing map using historical process data as good states of the technical facility in a learning phase;
determining and storing reference path regions in a preparation step, wherein the reference path regions are defined with the aid of a temporal sequence of neuron hits in the self-organizing map and tolerances of the neuron hits in the learning phase;
storing threshold values for Euclidean distances of the good states to relevant neurons in the self-organizing map in the learning phase;
evaluating current process data in the technical facility in the form of a state vector with the aid of the self-organizing map trained in the learning phase;
checking the Euclidean distances of the current state vector to the neuron hit as to whether the threshold value determined in the learning phase is exceeded;
checking a current path by comparison with the reference path regions determined in the learning phase and definition of a neuron to be hit with the aid of the relevant reference path region as long as the threshold value was not already exceeded in the check with the neuron hit; and
determining a symptom vector from the current state vector and either the neuron hit or the neuron that is to be hit, wherein the determining of the symptom vector is performed taking into account the threshold value of the relevant neuron, and wherein a symptom vector different from a zero vector flags the process anomaly, and the symptom vector specifies the process anomaly in more detail.

2. The method of claim 1, further comprising:
acquiring and storing the respective duration of the good states in addition to the sequence of neuron hits along a path in the learning phase; and
using the duration the good states is additionally used to check the duration of the current states and thereby to identify a process anomaly as long as the threshold value was not exceeded and the path did not deviate during the evaluation of the current process states.

3. The method of claim 1, further comprising:
sampling processes of the technical facility at discrete regular time intervals;
acquiring and storing the number of hits of a respective neuron instead of the respective duration of the good states; and
performing a check with the aid of the respective number of hits with respect to the current states instead of a check on the duration of the current states.

4. The method of claim 1, after the training, further comprising:
optimizing the self-organizing map; and
automatically calculating and storing the threshold values for the individual nodal points by a re-evaluation of good states.

5. The method of claim 1, further comprising applying a tolerance value to the threshold values.

6. The method of claim 2, further comprising:
sampling processes of the technical facility at discrete regular time intervals;
acquiring and storing the number of hits of a respective neuron instead of the respective duration of the good states; and
performing a check with the aid of the respective number of hits with respect to the current states instead of a check on the duration of the current states.

7. The method of claim 2, after the training, further comprising:
optimizing the self-organizing map; and
automatically calculating and storing the threshold values for the individual nodal points by a re-evaluation of good states.

8. The method of claim 3, after the training, further comprising:
optimizing the self-organizing map; and
automatically calculating and storing the threshold values for the individual nodal points by a re-evaluation of good states.

9. The method of claim 2, further comprising applying a tolerance value to the threshold values.

10. The method of claim 3, further comprising applying a tolerance value to the threshold values.

11. The method of claim 4, further comprising applying a tolerance value to the threshold values.

12. A computer program product comprising a non-transitory computer-readable storage medium, the non-transitory computer-readable storage medium storing instructions executable by a computer for improved identification of a process anomaly in a technical facility, the instructions comprising:
training a self-organizing map using historical process data as good states of the technical facility in a learning phase;
determining and storing reference path regions in a preparation step, wherein the reference path regions are defined with the aid of a temporal sequence of neuron hits in the self-organizing map and tolerances of the neuron hits in the learning phase;
storing threshold values for Euclidean distances of the good states to relevant neurons in the self-organizing map in the learning phase;
evaluating current process data in the technical facility in the form of a state vector with the aid of the self-organizing map trained in the learning phase;
checking the Euclidean distances of the current state vector to the neuron hit as to whether the threshold value determined in the learning phase is exceeded;
checking a current path by comparison with the reference path regions determined in the learning phase and definition of a neuron to be hit with the aid of the relevant reference path region as long as the threshold value was not already exceeded in the check with the neuron hit; and
determining a symptom vector from the current state vector and either the neuron hit or the neuron that is to be hit, wherein the determining of the symptom vector is performed taking into account the threshold value of the relevant neuron, and wherein a symptom vector different from a zero vector flags the process anomaly, and the symptom vector specifies the process anomaly in more detail.

13. The computer program product of claim 12, wherein the instructions further comprise:
acquiring and storing the respective duration of the good states in addition to the sequence of neuron hits along a path in the learning phase; and
using the duration the good states is additionally used to check the duration of the current states and thereby to identify a process anomaly as long as the threshold value was not exceeded and the path did not deviate during the evaluation of the current process states.

14. The computer program product of claim 12, wherein the instructions further comprise:
sampling processes of the technical facility at discrete regular time intervals;
acquiring and storing the number of hits of a respective neuron instead of the respective duration of the good states; and
performing a check with the aid of the respective number of hits with respect to the current states instead of a check on the duration of the current states.

15. The computer program product of claim 12, wherein, after the training, the instructions further comprise:
optimizing the self-organizing map; and
automatically calculating and storing the threshold values for the individual nodal points by a re-evaluation of good states.

16. The computer program product of claim 12, wherein the instructions further comprise applying a tolerance value to the threshold values.

17. A diagnostic system comprising:
means for training a self-organizing map using historical process data as good states of a technical facility in a learning phase;
means for determination and storage of reference path regions in the learning phase, wherein the reference path regions are definable with the aid of a temporal sequence of neuron hits in the self-organizing map and the tolerances for the neuron hits;
means for storage of threshold values for Euclidean distances of the good states to the relevant neurons in the self-organizing map in the learning phase;
means for evaluation of current process data in the technical facility in the form of a state vector with the aid of the self-organizing map trained in the learning phase;
means for checking the Euclidean distance of the current state vector to the neuron hit as to whether the threshold value determined in the learning phase is exceeded;
means for checking the current path by comparison with the reference path regions determined in the learning phase and for defining a neuron to be hit with the aid of the relevant reference path region as long as the threshold value was not already exceeded in the check with the neuron hit; and
means for determination of a symptom vector from the current state vector and either the neuron hit or the neuron that is to be hit,
wherein the determination is performed taking into account the threshold value of the relevant neuron, and
wherein a symptom vector different from a zero vector flags the process anomaly, and the symptom vector specifies the process anomaly in more detail.
